(19) United States
(12) Patent Application Publication
(10) Pub. No.: US 2007/0265856 A1
(43) Pub. Date: Nov. 15, 2007

(54) METHOD OF SELECTING A LIFTGATE

(76) Inventor: Rod Robinson, Tallmadge, OH (US)

Correspondence Address: BROUSE MCDOWELL LPA, 388 SOUTH MAIN STREET, SUITE 500, AKRON, OH, 44311, US

(21) Appl. No.: 11/382,588

(22) Filed: May 10, 2006

(51) Int. Cl. G06Q 10/00; G06Q 30/00

(52) U.S. Cl. 705/1

(57) ABSTRACT

A liftgate can be selected for a particular cargo and particular vehicle using the following steps: (a) providing categories of liftgates based on liftgate cycle ranges; (b) determining liftgate cycle requirements; (c) comparing the liftgate cycle requirements to the liftgate cycle ranges; (d) choosing the applicable category of liftgates; (e) determining cargo information; (f) determining vehicle information; and, (g) selecting at least one liftgate within the applicable category of liftgates corresponding to the cargo and vehicle information.

### I. BACKGROUND OF THE INVENTION

A. Field of Invention

This invention pertains to the art of methods and apparatuses regarding liftgates and more specifically to methods and apparatuses regarding the selection of a liftgate based, in part, on the liftgate cycle requirements.

B. Description of the Related Art

It is well known in the art to attach liftgates to vehicle trailers or other types of vehicle cargo holds to assist with loading and unloading of the vehicles. In general, liftgates include a platform or deck and some lift mechanism, often including a hydraulic system, used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

The particular cargo that is to be moved by a liftgate varies widely as cargo volume, weight, number of pieces, cargo containers, etc. come in nearly unlimited ranges. Sometimes the cargo is manually taken to and from the liftgate platform while other times a cargo handling device, such as a dolly, is used. It may be desirable to lift the cargo handling device along with the cargo on the liftgate. The types and styles of vehicles that transport cargo and require a liftgate are numerous. Some non-limiting examples include trailers separate from the trucks that haul them, trucks having the trailer portion attached to the same frame, pick-up trucks, vans, and busses. Many vehicles require a liftgate at the back of the trailer or cargo hold but others required a liftgate on the side of the vehicle. To meet these varying cargo and vehicle needs, numerous types and styles of liftgates are known in the art. Some non-limiting examples include conventional liftgates, flip-a-way or fold-up liftgates, rail type liftgates, and special purpose liftgates. Generally, each type of liftgate has multiple options including various platform sizes and various load capacities.

Given these numerous variables, a problem well known in the art is the difficulty in determining the particular liftgate that is best suited for a particular vehicle and cargo. It is known in the liftgate art to provide a liftgate specification method or process. Often this method is provided via web access to a liftgate provider. One known web based method requires that the person selecting a liftgate first identify the vehicle type. Once the vehicle type is selected, the loading style (rear or side loading) is identified. Next, the load capacity is identified and then the particular type of liftgate desired is identified. Finally, additional details such as trailer bed height are identified. With this info provided, computer software searches through a list of liftgates and selects one or more particular models that meet the entered criteria. From this list of models, the person can make the final liftgate selection. Another known web based method provides a specification form having data entry fields for multiple factors including: the type of vehicle, the type of vehicle door, the maximum cargo weight, the cargo dimensions, etc. After entering data in at least some of the data fields, the person selecting a liftgate can specify which (some or all) of the data entry fields are to be considered in the search. With this info provided, computer software searches through a list of liftgates and selects one or more particular models that meet the particular data fields considered in the search. From this list of models, the person can make the final liftgate selection.

While these known methods aid a person is selecting a liftgate, they too often lead to dissatisfied customers. This dissatisfaction is often based on the fact that the liftgate selected does not perform as long (product life) as the customer expected. Dissatisfaction may alternatively be based on the expense of the purchase of a liftgate that is actually of greater capacity than required (this is often termed “over purchasing”). Applicant believes the solution lies in careful consideration of a factor greatly downplayed and nearly ignored in the selection of a liftgate—the required liftgate cycle time. Liftgate cycle time is a variable that is influenced by operating speed and travel distance of the liftgate.

The present invention provides improved methods and apparatuses for selecting a liftgate and thereby overcomes the foregoing difficulties and others while providing better and more advantageous overall results.

### II. SUMMARY OF THE INVENTION

According to one embodiment of this invention, a method of selecting a liftgate for a vehicle may include the following steps: (a) providing categories of liftgates based on liftgate cycle ranges; (b) determining liftgate cycle requirements; (c) comparing the liftgate cycle requirements to the liftgate cycle ranges; (d) choosing the applicable category of liftgates; (e) determining cargo information; (f) determining vehicle information; and, (g) selecting at least one liftgate within the applicable category of liftgates corresponding to the cargo and vehicle information.

According to another embodiment of this invention, the step of determining liftgate cycle requirements may include the step of determining yearly liftgate cycle requirements.

According to another embodiment of this invention, the step of determining liftgate cycle requirements may include the step of determining lifetime liftgate cycle requirements.

According to still another embodiment of this invention, the step of providing categories of liftgates based on liftgate cycle ranges may include the steps of: (1) providing a first category of liftgates based on a cycle range of less than 2500 cycles per year; (2) providing a second category of liftgates based on a cycle range of 2500 to 5000 cycles per year; and, (3) providing a third category of liftgates based on a cycle range of greater than 5000 cycles per year.

According to another embodiment of this invention, the method may include the step of determining a liftgate warranty request.

According to another embodiment of this invention, the method may include the step of providing a liftgate warranty based substantially on the liftgate cycle requirements.

According to still another embodiment of this invention, the method my include the step of classifying the liftgate needs into a particular market segment.

According to another embodiment of this invention, a method of selecting a liftgate for a vehicle may include the following steps: (a) providing a computer with software including data providing categories of liftgates based on liftgate cycle ranges; (b) accessing a liftgate selection computer screen; (c) entering liftgate cycle requirements thereby enabling the software to compare the liftgate cycle requirements to the liftgate cycle ranges and to choose the applicable category of liftgates; (d) entering cargo information; (e) entering vehicle information; and, (f) enabling the software to select at least one liftgate within the applicable category of liftgates corresponding to the cargo and vehicle information.

According to another embodiment of this invention, the step of accessing a liftgate selection computer screen, may include the step of accessing the liftgate selection computer screen using a website.

According to another embodiment of this invention, the method may also include the step of enabling the software to provide a liftgate warranty based substantially on the liftgate cycle requirements.

According to another embodiment of this invention, the method may also include the steps of: (1) entering a liftgate warranty request; and, (2) enabling the software to compare the liftgate warranty request to the liftgate cycle requirements to determine if the they are compatible.

One advantage of this invention is that liftgates can be more accurately selected and greatly reduce the practice of under specifying or over purchasing of a liftgate for a specific delivery application.

Another advantage of this invention is that liftgate warranties can be properly matched to the liftgate cycle times.

Another advantage of this invention is that the method can be used via a website, via a computer not web connected, and via other mediums as well.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of a vehicle equipped with a liftgate that may be selected according to the methods and apparatuses of this invention.

FIG. 2 is a flowchart describing the steps in selecting a liftgate according to one embodiment of this invention.

FIG. 3 is a flowchart describing the steps in selecting a liftgate according to another embodiment of this invention.

FIG. 4 shows a flowchart describing some of the steps that may be used in determining cargo information.

FIG. 5 is a flowchart describing some of the steps that may be used in determining vehicle information.

FIG. 6 a schematic of an exemplary web-enabled system that may be used for practicing another embodiment of this invention.

FIG. 7 shows a flowchart describing the steps in selecting a liftgate according to yet another embodiment of this invention using a computer.

FIG. 8 shows a flowchart describing the steps in selecting a liftgate according to still another embodiment of this invention.

FIG. 9 is a sample liftgate specification computer screen that may be used with one embodiment of this invention.

### IV. DETAILED DESCRIPTION OF THE INVENTION

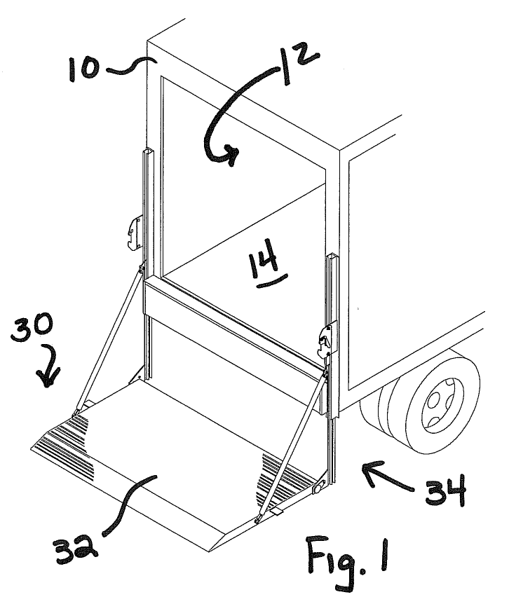

Referring now to the drawings wherein the showings are for purposes of illustrating embodiments of the invention only and not for purposes of limiting the same, FIG. 1 shows a vehicle 10 having a cargo hold 12 equipped with a liftgate 30 that may be selected according to the methods and apparatuses of this invention. The liftgate 30 includes a platform 32 and a lift mechanism 34 that can raise the platform 32 to the level of the trailer floor 14 and lower the platform 32 to the ground level, as shown in FIG. 1. As the operation of a liftgate 30 is well known in the art, it will not be discussed in detail here. While the liftgate 30 shown is the style known as a rail type liftgate, it is to be noted that this invention will work with any liftgate style, type and size, with any cargo style, type and size, and with any vehicle style, type and size. It should also be noted that the term “liftgate” encompasses all types of vehicle elevators including, but not limited to, those referred to as tailgate lifts, elevating platforms, loading platforms and the like.

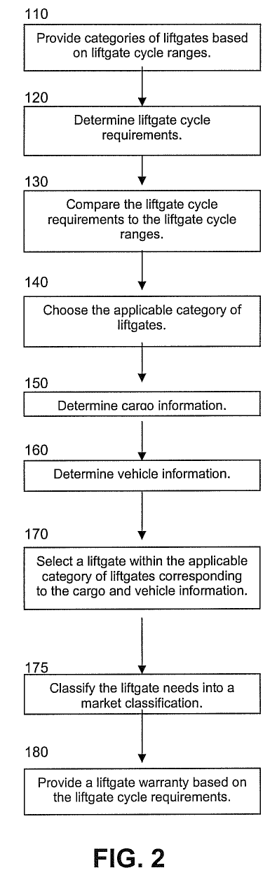

FIG. 2 shows a flowchart describing the steps in selecting a liftgate according to one embodiment of this invention. Note that for this embodiment as well as all the embodiments described below, some steps may be optional.

In step 110, at least two categories of liftgates are provided based on the individual liftgate cycle ranges. A “liftgate cycle” means the movement of a liftgate platform from one level position to a second level position and then back to the first level position. Thus, for example, a liftgate cycle is the movement of a liftgate platform from the lower ground position up to the upper vehicle bed position and then back down to the lower ground position. Similarly, a liftgate cycle is also the movement of a liftgate platform from the upper vehicle bed position down to the lower ground position and then back up to the upper vehicle bed position. Often, customers who are selecting a liftgate know the liftgate cycle requirements. The liftgate cycle range categories may be provided on any tangible medium including paper mediums such as catalogs, notebooks, spin dials and other such mediums well known in the art. In another embodiment, described further below, the medium may be a computer.

The particular liftgate cycle range categories can be any chosen with sound engineering judgment. For one example, the liftgate cycle range categories may be based on the total number of cycles to be used by a liftgate throughout its product lifetime. For a more specific example, one category of liftgates may have an expected lifetime cycle range of up to 12,500 cycles while another liftgate cycle range may extend to 25,000 cycles. In this case, all the available liftgates would be divided into a first category having lifetime cycle life of up to 12,500 cycles and the remaining liftgates would be placed in the second category having an expected lifetime cycle range of between 12,500 and 25,000 cycles.

For a second example, the liftgate cycle range categories may be based on the number of cycles to be used by a liftgate over a specific time period. For a more specific example, one category of liftgates may be based on a yearly cycle range of less than 2,500 cycles per year, a second category may be based on a cycle range of 2,500 to 5,000 cycles per year and a third category of liftgates may be based on a cycle range of greater than 5,000 cycles per year. It is to be understood that the liftgate cycle ranges can be based on other specific time periods such as cycles per day, cycles per week or cycles per month. In some cases, the person selecting will know how many days per week the liftgate will be used and/or how many weeks per year the liftgate is to be used. Liftgate cycle information based on these relatively smaller time periods can be easily converted into yearly cycle ranges (or any other time period), if desired, by simple arithmetic as is well known in the art.

For a third example, the liftgate cycle range categories may be based on the actual time the liftgate is being operated. Liftgate operating time in completing a cycle can vary greatly depending on the particular liftgate, the load being raised and the bed height. The time for one liftgate cycle could range, for example, between 15 seconds and 3 minutes. Thus, one category of liftgates may be based on a total daily liftgate use time of less than 10 minutes, a second category may be based on a total daily liftgate use time of between 10 minutes and 40 minutes, and a third category may be based on a total daily liftgate use time of over 40 minutes. The total daily liftgate use times may be easily calculated by multiplying the number of expected cycles times the actual time for each cycle. It may be known, for example, that the lift gate will require 10 cycles per day and that each cycle takes 15 seconds. In this case, the total daily actual operation time would be 150 seconds, or 2 minutes and 30 seconds (10 cycles per day times 15 seconds per cycle). For another example, it may be known that the lift gate will require 25 cycles per day and that each cycle takes 2 minutes. In this case, the total daily actual operation time would be 50 minutes (25 cycles per day times 2 minutes per cycle). Using actual liftgate operating time has the benefit of being especially useful when bed height data (which directly impacts the time per cycle required for the liftgate) is known.

The particular cycle ranges and the corresponding liftgate categories can vary according to the types of liftgates provided and the particular cycle ranges requested by customers.

In step 120, the particular liftgate cycle requirements are determined. As described above, the requirements may be specific time period requirements, or they may be lifetime requirements or they may be actual operating times. Thus, for example, the person selecting a liftgate may determine that a yearly cycle requirement is 2,500 cycles per year. Alternatively, the person selecting a liftgate may determine that the lifetime liftgate cycle requirement is 25,000 cycles.

In step 130, the liftgate cycle requirements are compared to the liftgate cycle ranges. Then, in step 140, the applicable category of liftgates is chosen. Thus, for example, if the liftgate cycle requirement is 3,000 cycles per year, then the appropriate cycle range would be 2,500 to 5,000 cycles per year. This range may correspond to the second category of liftgates. As a result, all the liftgates to be considered will meet the cycle requirement needs of the customer. This greatly minimizes the chances that the customer will be dissatisfied with the particular liftgate selected.

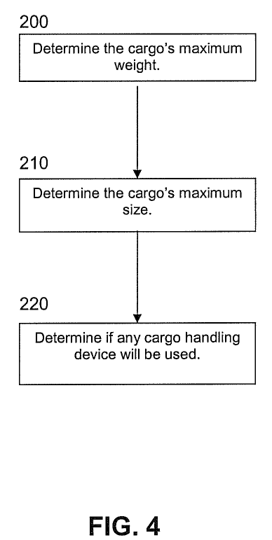

In step 150, the cargo information is determined. This type of information is well known in the art and thus will not be described in detail here. However, examples of the cargo information that may be determined are provided in FIG. 4. In step 200, the cargo's maximum weight may be determined. In step 210, the cargo's maximum size or volume may be determined. In step 220, whether a cargo handling device will be used can also be determined. All of these factors and other cargo related factors are generally important in selecting the appropriate liftgate.

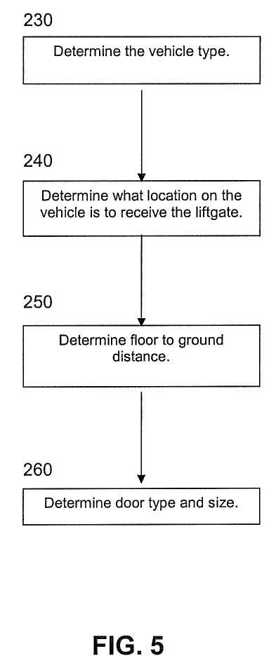

In step 160, the vehicle information is determined. As with the cargo information, this is information commonly determined and will not be described in detail. However, some non-limiting examples of vehicle information are provided in FIG. 5. In step 230, the vehicle type is determined. By “vehicle type” it is meant, for example, a semi-trailer or a pick-up truck or a van. In step 240, the location on the vehicle to receive the liftgate is determined. Thus, for example, on some vehicles the liftgate is to be received at the back end of the vehicle. In other cases, the liftgate is to be received on the side of the vehicle. In step 250, the distance from the floor of the cargo hold to the ground may be determined. In step 260, the particular type and size of door, through which the cargo is placed when entering the vehicle may be determined. This type of information is also generally important in selecting the appropriate liftgate.

In step 170, a liftgate within the applicable category is selected corresponding to the cargo and vehicle information. It should be clear that because the cycle requirements were considered first, and thus the liftgates under review are in the appropriate category, the customer is likely to be satisfied with the liftgate selected. As one non-limiting example, the person selecting a liftgate may have determined that 3,000 cycles per year are required from the liftgate. As noted above, this means that only those liftgates providing the required cycle range will be considered. Within that particular category of liftgates, the list can be narrowed when the cargo and vehicle information is added. Thus, for example, it may be determined that a rail type liftgate (as shown in FIG. 1) having a particular platform size and a particular load capacity would be a good fit for a particular customer need.

In step 175, an optional step, some or all of the information provided (cycle requirements, cargo information, vehicle information, etc.) can be used to classify the customer's liftgate needs into a particular market segment. This classification may be helpful to both the customer as well as the liftgate provider in selecting other liftgates for other applications. While the number and titles of such classifications can vary as desired, in one embodiment three market segments are provided and are titled Vocational, Commercial Moderate and Commercial Heavy. Each market segment classification may correspond, in whole or in part, to the liftgate related information provided by the customer. Thus, as one non-limiting example, the Vocational classification may correspond to liftgates requiring not more than 2,500 cycles per year and cases where a trailer is not used. Other factors, such as load capacity and/or no palletized cargo may (or may not) be used in classifying the particular customer's liftgate needs in the Vocational classification. As another non-limiting example, the Commercial Moderate classification may correspond to liftgates requiring between 2,500 and 5,000 cycles per year. Other factors, such as need for liftgate customization may (or may not) be used in classifying the particular customer's liftgate needs in the Commercial Moderate classification. As still another non-limiting example, the Commercial Heavy classification may correspond to liftgates requiring over 5,000 cycles per year and load capacities over 3300 pounds (lbs). Once again, other factors, such as a minimum distance from the floor of the cargo hold to the ground may be (or may not) be used in classifying the particular customer's liftgate needs in the Commercial Heavy classification.

In step 180, another an optional step, a liftgate warranty may be provided based on the liftgate cycle requirements or based on the market classification. Thus, for example, if the liftgate cycle requirement is 2,500 cycles per year, the warranty may be for five years. If the liftgate cycle requirement is 5,000 cycles per year, as an alternate example, the liftgate warranty may be for three years. This greatly minimizes the chances that the customer will be dissatisfied because the warranty corresponds to the liftgate cycle requirements or market classification and is known by the customer at the time of purchase.

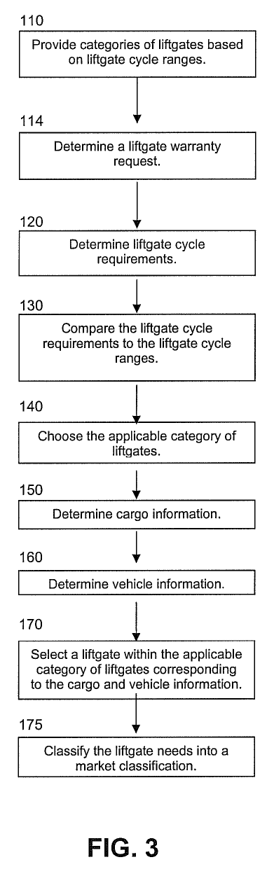

FIG. 3 shows a flowchart describing the steps in selecting a liftgate according to another embodiment of this invention. Many of the steps are the same as provided in FIG. 2. As a result, these steps will not be reviewed again. However, there are two important differences with this embodiment. First note that step 180, found in FIG. 2 is not provided in this embodiment. However, a new step, step 114, is provided. In step 114, a liftgate warranty request is determined. Thus, for example, the selector of a liftgate may determine that a five year warranty is desired. With this information, step 120 (where the liftgate cycle requirements are determined) can take into account the liftgate warranty request. As a result, only those liftgates that provide both the required warranty and cycle requirements will be considered further.

It should be noted that while liftgate cycle ranges, cargo information and vehicle information have been emphasized so far many other liftgate variables may also be considered. Some non-limiting examples include whether or not the liftgate will be used with dock loading, whether or not a cart stop will be provided and whether or not a retention ramp is required. All of these options, as well as many others, can easily be added to the methods and apparatuses of this invention including market classification.

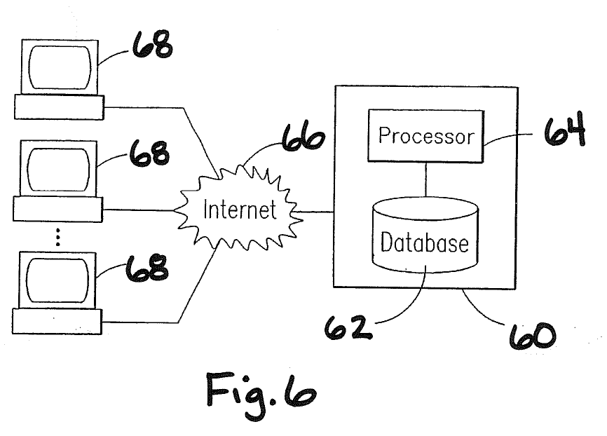

FIG. 6 is a schematic representation of an exemplary web-enabled system that may be used by a person to select a liftgate. In one embodiment, a website, such as may be operated and managed by the assignee of the present invention, has appropriate software to process the information supplied by the person in making the liftgate selection. By way of non-limiting example, the site may comprise a server 60 made up of a database 62 coupled to a processor 64 that processes in respective processing modules electronic data configured to enable online activation over a suitable telecommunications medium, such as a web-enabled communications medium 66. A telecommunications device 68, such as a computer loaded with any commercially available web browser may be used by the person to enter information, as described below in greater detail, to download web pages from server 60 and to transmit data back to server 60. In an alternate embodiment, the computer may not be connected to the web but may have adequate software available in its hard drive or via a network connection. This invention is intended to encompass all such computer variations.

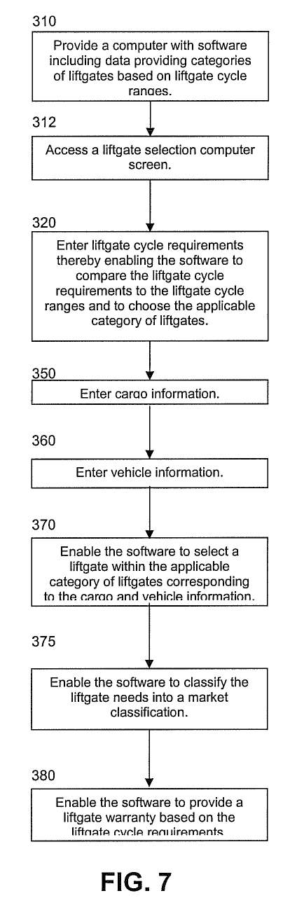

FIG. 7 shows a flow chart describing the steps in selecting a liftgate according to yet another embodiment of this invention. In step 310, a computer is provided that includes appropriate software that has data providing the categories of liftgates based on liftgate cycle ranges. This can be the same information described above regarding step 110 except in appropriate form for use by a computer.

In step 312, an appropriate computer screen is accessed so that the liftgate selection can be made. As noted above, the computer screen accessed may be via a website connection or may be via a computer independent of a web connection.

In step 320, the liftgate cycle requirements are entered. The particular cycle requirements can be any of those described above regarding steps 110 and 120. Once the cycle requirements have been entered, the computer software will then compare the requirements to the cycle ranges and choose the applicable category of liftgates. The logic for this is similar to that described above regarding steps 130 and 140. It should be noted that the particular manner in which this information is entered (both for this step and all remaining steps where information is entered) can be of any type or method chosen with sound engineering judgment. Thus, for example, this information may be entered using a drop down box or as an open data entry box. These types of options are well known to those of skill in the art and thus will not be described in detail. This invention, however, is intended to encompass all methods of entering data into the computer.

In steps 350 and 360, cargo and vehicle information is entered. The particular information entered may be the same as described in steps 150 and 160.

In step 370, the software is enabled to select a liftgate within the applicable category of liftgates corresponding to the cargo and vehicle information. This step of enabling may be any chosen with sound engineering judgment. Thus, as one non-limiting example, the computer screen may include a “button” that can be selected by the user's computer mouse. In other words, once the data described above has been entered, the user can press this button to enable the computer software to make the required selection.

In step 375, an optional step, the software is enabled to classify the customer's needs into a particular market segment. The particular market segment and the variables used to establish the market segment can vary as described above regarding step 175. As with step 370, this step of enabling may be any chosen with sound engineering judgment.

In step 380, the software is enabled to provide a warranty for the liftgate based on the cycle requirements or based on the market classification. This is similar to step 180, described above except for accomplished using the computer software. Note that this step is optional.

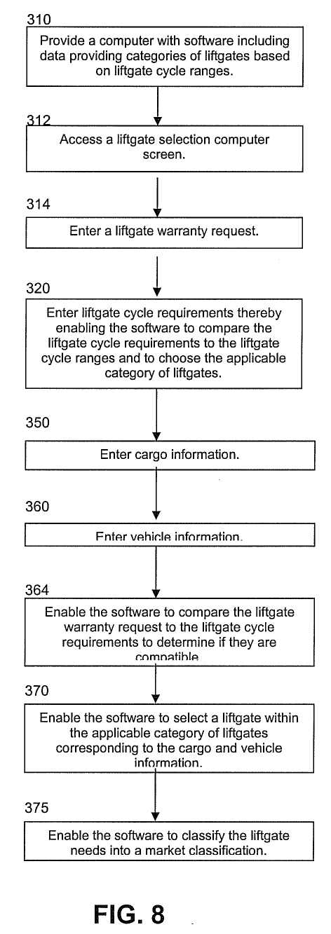

FIG. 8 shows a flow chart describing the steps in selecting a liftgate according to yet another embodiment of this invention. Many of the steps for this embodiment are similar to those shown in FIG. 7. As a result, details of the common steps will not be reviewed. The differences, however, will be emphasized. Note first that step 380 provided in FIG. 7 is not provided in the embodiment of FIG. 8. Instead, a new step 314 is provided. In step 314 a particular warranty request is entered. For example, the person selecting a liftgate may choose that a five year warranty is desired. Note also step 364 where the computer software is enabled to compare the liftgate warranty request to the liftgate cycle requirements to determine if they are compatible. This step would greatly minimize the chance for a dissatisfied customer because any discrepancy between the warranty requested and the liftgate cycle requirements would be determined prior to the purchase of a liftgate. The customer could then either modify the warranty request or the liftgate cycle requirements in order to find a liftgate that will best meet the particular needs of the customer.

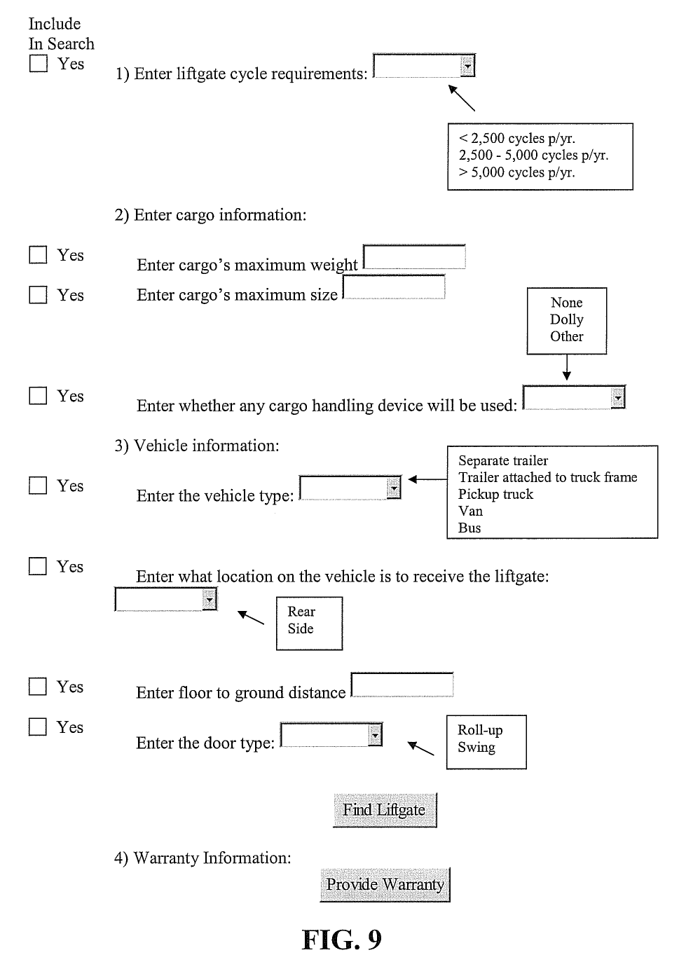

FIG. 9 illustrates one non-limiting example of a liftgate specification screen that may be used primarily according to the embodiment shown in FIG. 7. The specification screen is accessed according to step 312. In section 1), the user enters the liftgate cycle requirements so that the computer can choose the applicable category of liftgates according to step 320. Note that while section 1) illustrates the use of a drop down box, this is just one non-limiting method of entering the liftgate cycle requirement. In section 2), the user enters the cargo information according to step 350. Note that while section 2) illustrates the use of multiple data entry boxes as well as a drop down box, this is just one non-limiting method of entering the cargo information. In section 3), the user enters the vehicle information according to step 360.

Note that the liftgate specification screen of FIG. 9 also illustrates another liftgate selection option not discussed with the embodiment shown in FIG. 7. The additional liftgate selection option is the ability to specify which (some or all) of the data entry fields are to be considered in the search. This is accomplished by selecting (or not selecting) the box next to “Yes” for each data entry field. This option is helpful in cases where the user does not know all of the liftgate specification information.

With reference still to FIGS. 7 and 9, once all the information to be entered has been entered and all applicable data entry fields have been specified, the user enables the software to select a liftgate according to step 370. In this example, the software is enabled when the user selects the button labeled “Find Liftgate.” When enabled, the computer software searches through a list of liftgates and selects one or more particular models that meet the particular data fields considered in the search. From this list of models, the user can make the final liftgate selection. In section 4), the user enables the software to provide a warranty according to step 380. In this example, the software is enabled when the user selects the button labeled “Provide Warranty.” When enabled, the computer software provides a warranty corresponding to the liftgate cycle category selected by the user.

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A method of selecting a liftgate for a vehicle comprising the steps of:
providing at least two categories of liftgates based on at least two liftgate cycle ranges;
determining liftgate cycle requirements;
comparing the liftgate cycle requirements to the liftgate cycle ranges;
choosing the applicable category of liftgates;
determining liftgate related cargo information;
determining liftgate related vehicle information; and,
selecting at least one liftgate within the applicable category of liftgates corresponding to the liftgate related cargo and vehicle information.

2. The method of claim 1 wherein the step of, determining liftgate cycle requirements, comprises the step of:
determining specific time period liftgate cycle requirements.

3. The method of claim 2 wherein the step of, providing at least two categories of liftgates based on at least two liftgate cycle ranges, comprises the step of:
providing at least three categories of liftgates based on at least three liftgate cycle ranges.

4. The method of claim 1 further comprising the step of:
classifying liftgate needs into a market segment.

5. The method of claim 1 wherein the step of, determining liftgate cycle requirements, comprises the step of:
determining lifetime liftgate cycle requirements.

6. The method of claim 1 wherein prior to the step of, determining liftgate cycle requirements, the method comprises the step of:
determining a liftgate warranty request.

7. The method of claim 1 further comprising the step of:
providing a liftgate warranty based substantially on the liftgate cycle requirements.

8. The method of claim 1 wherein the step of, determining liftgate related cargo information, comprises the steps of:
determining the cargo's maximum weight;
determining the cargo's maximum size; and,
determining if any cargo handling device will be used.

9. The method of claim 1 wherein the step of, determining liftgate related vehicle information, comprises the steps of:
determining the vehicle type;
determining what location on the vehicle is to receive the liftgate;
determining floor to ground distance; and,
determining door type and size.

10. The method of claim 1 wherein the step of, providing at least two categories of liftgates based on at least two liftgate cycle ranges, comprises the steps of:
providing the categories of liftgates on a paper medium.

11. The method of claim 1 wherein the step of, providing at least two categories of liftgates based on at least two liftgate cycle ranges, comprises the steps of:
providing the categories of liftgates on a computer.

12. The method of claim 1 wherein the step of, determining liftgate cycle requirements, comprises the step of:
determining actual liftgate operation requirements.

13. A computerized method of selecting a liftgate for a vehicle, comprising the steps of:
providing a computer with software including data providing at least two categories of liftgates based on at least two liftgate cycle ranges;
accessing a liftgate selection computer screen;
entering liftgate cycle requirements thereby enabling the software to compare the liftgate cycle requirements to the liftgate cycle ranges and to choose the applicable category of liftgates;
entering liftgate related cargo information;
entering liftgate related vehicle information; and,
enabling the software to select at least one liftgate within the applicable category of liftgates corresponding to the liftgate related cargo and vehicle information.

14. The method of claim 13 wherein the step of, accessing a liftgate selection computer screen, comprises the step of:
accessing the liftgate selection computer screen using a website.

15. The method of claim 13 wherein the step of, entering liftgate cycle requirements, comprises the step of:
entering specific time period liftgate cycle requirements.

16. The method of claim 15 wherein the step of, providing a computer with software including data providing at least two categories of liftgates based on at least two liftgate cycle ranges, comprises the step of:
providing at least three categories of liftgates based on at least three liftgate cycle ranges.

17. The method of claim 13 further comprising the step of:
enabling the software to classify liftgate needs into a market segment.

18. The method of claim 13 wherein the step of, entering liftgate cycle requirements, comprises the step of:
determining lifetime liftgate cycle requirements.

19. The method of claim 13 wherein the step of, entering liftgate cycle requirements, comprises the step of:
determining actual liftgate operation requirements.

20. The method of claim 13 wherein:
the method further comprises the step of entering a liftgate warranty request; and,
prior to the step of, enabling the software to select at least one liftgate within the applicable category of liftgates corresponding to the liftgate related cargo and vehicle information, the method comprises the step of enabling the software to compare the liftgate warranty request to the liftgate cycle requirements to determine if the they are compatible.

21. The method of claim 13 further comprising the step of:
enabling the software to provide a liftgate warranty based substantially on the liftgate cycle requirements.

22. The method of claim 13 wherein:
the step of, entering liftgate related cargo information, comprises the steps of:
entering the cargo's maximum weight;
entering the cargo's maximum size; and,
entering any type of cargo handling device that will be used; and,
the step of, entering liftgate related vehicle information, comprises the steps of:
entering vehicle type;
entering what location on the vehicle is to receive the liftgate;
entering floor to ground distance; and,
entering door type and size.

23. A computerized method of selecting a liftgate for a vehicle, comprising the steps of:
providing a computer with software including data providing at least three categories of liftgates based on at least three yearly liftgate cycle ranges;
accessing a liftgate selection computer screen;
entering yearly liftgate cycle requirements thereby enabling the software to compare the yearly liftgate cycle requirements to the yearly liftgate cycle ranges and to choose the applicable category of liftgates;
entering liftgate related cargo information;
entering liftgate related vehicle information; and,
enabling the software to: (a) select at least one liftgate within the applicable category of liftgates corresponding to the liftgate related cargo and vehicle information; and, (b) provide a liftgate warranty based substantially on the liftgate cycle requirements.

24. The method of claim 23 wherein the step of, accessing a liftgate selection computer screen, comprises the step of:
accessing the liftgate selection computer screen using a website.
